(19) United States
(12) Patent Application Publication
(10) Pub. No.: US 2005/0281309 A1
(43) Pub. Date: Dec. 22, 2005

(54) Highly efficient surface emitting laser device, laser-pumping unit for the laser device, and method of manufacturing the laser-pumping unit

(75) Inventor: Taek Kim, Gyeonggi-do (KR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Samsung Electronics Co., Ltd., Gyeonggi-do (KR)

(21) Appl. No.: 11/087,800

(22) Filed: Mar. 24, 2005

(30) Foreign Application Priority Data
Jun. 19, 2004 (KR) 10-2004-0045847

(51) Int. Cl. H01S 3/091

(52) U.S. Cl. 372/71; 372/70; 372/75

(57) ABSTRACT

Provided are a VECSEL device, which improves optical pumping efficiency by including a mirror reflecting an optical pumping beam, and a method of manufacturing the same. The device includes a lase-pumping unit emitting light having a predetermined wavelength; and a pump laser providing an optical pumping laser beam to the laser-pumping unit. Herein, the laser-pumping unit includes an active layer absorbing the optical pumping laser beam to emit light having a predetermined wavelength; a first reflector reflecting the light emitted from the active layer; and a second reflector reflecting the optical pumping laser beam, which are not absorbed in the active layer but transmit the first reflector, toward the active layer.

Priority is claimed to Korean Patent Application No. 10-2004-0045847, filed on Jun. 19, 2004, in the Korean Intellectual Property Office, the disclosure of which is incorporated herein in its entirety by reference.

### BACKGROUND OF THE INVENTION

1. Field of the Invention

The present invention relates to vertical external cavity surface emitting laser (VECSEL) devices and method of manufacturing the same, and more particularly, to VECSEL devices that includes a mirror reflecting an optical pumping beam to improve optical pumping efficiency, and methods of manufacturing the same.

2. Description of the Related Art

Generally, semiconductor lasers can be categorized into edge emitting lasers in which oscillated beam are emitted in a horizontal direction of a substrate and surface emitting lasers (or vertical cavity surface emitting layers (VCSELs)) in which oscillated beam are emitted in a vertical direction of a substrate. Since the VCSELs oscillates in single longitudinal-mode of a very narrow spectrum and emits a beam having a small radiation angle, they have advantages such as connection efficiency is high and integration with other devices is easy. However, a conventional VCSEL makes single transverse-mode oscillation difficult in comparison with the edge-emitting lasers. Single transverse-mode operation of the conventional VCSEL requires a small oscillation region, thus resulting in low output.

To utilize the advantages of the VCSEL and embody high output operation, vertical external cavity surface emitting lasers (VECSELs) have been proposed. The VECSELs increases a gain region by adopting an external mirror instead of a distributed Brag reflector (DBR) for the VCSEL and obtains a high output of several to several tens of watts (W) or higher.

FIG. 1 is a schematic cross-sectional view of a conventional VECSEL device 10.

Referring to FIG. 1, the VECSEL device 10 includes a substrate 12, a high reflective layer 13 such as a DBR, and an active layer 14 such as a multiple quantum well (MQW) gain region having a resonant periodic gain (RPG) structure, which are sequentially stacked on a heat sink 11. The heat sink 11 radiates heat generated by the active layer 14 and cools the active layer 14. The VECSEL device 10 further includes an external mirror 16 instead of an upper DBR. Thus, a cavity is formed between the high reflective layer 13 disposed under the active layer 14 and the external mirror 16.

The operation of the VECSEL device 10 is as follows. At the outset, an optical pumping laser beam of wavelength λ1 is emitted from a pump laser 15 and incident on the active layer 14 via a collimating lens 17. Then, the active layer 14 is excited by the laser beam λ1 and emits light of wavelength λ2. The light emitted from the active layer 14 are repetitively reflected between the lower DBR 13 and the external mirror 16 via the active layer 14. In this process, some of the light λ2 that is amplified in the active layer 14 is output as laser beam through the external mirror 16, while other parts of the light thereof are reflected again and incident on the active layer 14 to contribute to optical pumping.

FIG. 2 is a schematic cross-sectional view of another conventional VECSEL device 20.

Referring to FIG. 2, the VECSEL device 20 is different from the VECSEL 10 shown in FIG. 1 in that an optical pumping laser beam of wavelength λ1 emitted from a pump laser 25 transmit an external mirror 26 and are vertically incident on an active layer 24. A laser beam of wavelength λ2, which is emitted from the active layer 24 and radiated through the external mirror 26, is reflected by a beam splitter 28 and thus, can be separated from the optical pumping laser beam λ1.

In the case of the conventional VECSEL devices 10 and 20, the optical pumping laser beam λ1 having a short wavelength is partially absorbed in the active layers 14 and 24. Thus, the remaining laser beam λ1 unabsorbed in the active layers 14 and 24 transmit the lower DBRs 12 and 22 and are directly absorbed in the substrates 11 and 22 formed of, for example, GaAs. As a result, the remaining laser beam λ1 unabsorbed in the active layers 14 and 24 cannot contribute to optical pumping, thus degrading the optical pumping efficiency of a pump laser.

### SUMMARY OF THE INVENTION

The present invention provides a vertical external cavity surface emitting laser (VECSEL) and a laser-pumping unit laser-pumping unit for the VECSEL, which improve optical pumping efficiency by including a mirror that reflects the remaining optical pumping laser beam unabsorbed in an active layer, toward the active layer.

The present invention also provides a method of manufacturing the above-described laser-pumping unit for the VECSEL device.

According to an aspect of the present invention, there is provided a semiconductor laser device including a laser-pumping unit emitting light having a predetermined wavelength and a pump laser providing an optical pumping laser beam to the laser-pumping unit. The laser-pumping unitlaser-pumping unit includes an active layer absorbing the optical pumping laser beam to emit light having a predetermined wavelength; a first reflector reflecting the light emitted from the active layer; and a second reflector reflecting the optical pumping laser beam, which are not absorbed in the active layer but transmit the first reflector, toward the active layer.

The semiconductor laser device further includes an external mirror located outside the laser-pumping unitlaser-pumping unit, transmitting some of the light emitted from the laser-pumping unitlaser-pumping unit to output the transmitted beam as laser beam, and reflecting the other thereof to permit the reflected beam to be reabsorbed in the laser-pumping unitlaser-pumping unit.

According to another aspect of the present invention, there is provided a method of manufacturing a laser-pumping unitlaser-pumping unit for a surface emitting laser device, which absorbs an optical pumping laser beam emitted from a pump laser and emits light having a predetermined wavelength. The method includes forming a sacrificial layer on a substrate; stacking a first reflector, which is a distributed Brag reflector, on the sacrificial layer; stacking an active layer on the first reflector, the active layer absorbing the optical pumping laser beam to emit light having a predetermined wavelength; stacking a light transmissive heat sink on the active layer; separating the substrate from the first reflector by etching the sacrificial layer; and depositing a second reflector under the first reflector, the second reflector reflecting the optical pumping laser beam, which is not absorbed in the active layer but transmits through the first reflector, toward the active layer.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of a conventional vertical external cavity surface-emitting laser (VECSEL);

FIG. 2 is a cross-sectional view of another conventional VECSEL;

FIG. 3 is a cross-sectional view of a surface emitting laser device according to an embodiment of the present invention;

FIG. 4 is a cross-sectional view of a surface emitting laser device according to another embodiment of the present invention;

FIG. 5 is a cross-sectional view of a surface emitting laser device according to yet another embodiment of the present invention;

FIG. 6 is a cross-sectional view of a surface emitting laser device according to a further embodiment of the present invention;

FIG. 7 is a cross-sectional view of a surface emitting laser device according to yet a further embodiment of the present invention; and

FIGS. 8A through 8D are cross-sectional views illustrating a method of manufacturing a laser-pumping unit used for the surface emitting laser devices shown in FIGS. 5 and 6.

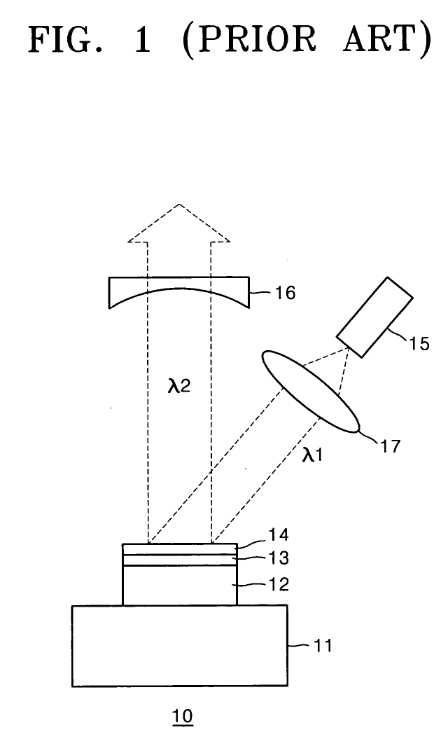

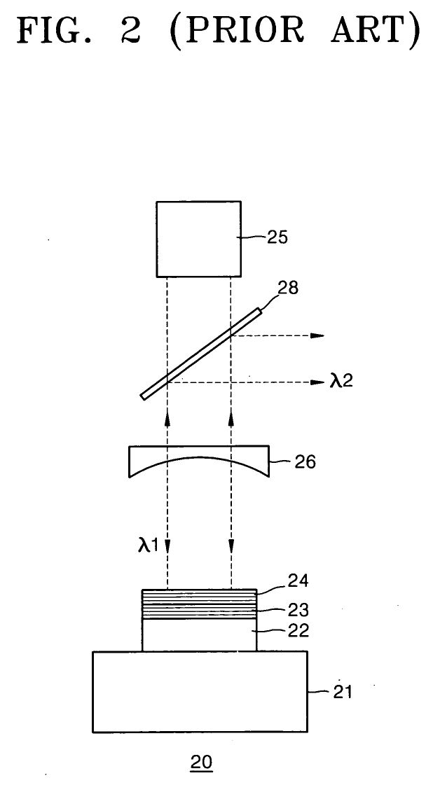

### DETAILED DESCRIPTION OF THE INVENTION

The present invention will now be described more fully with reference to the accompanying drawings, in which exemplary embodiments of the invention are shown.

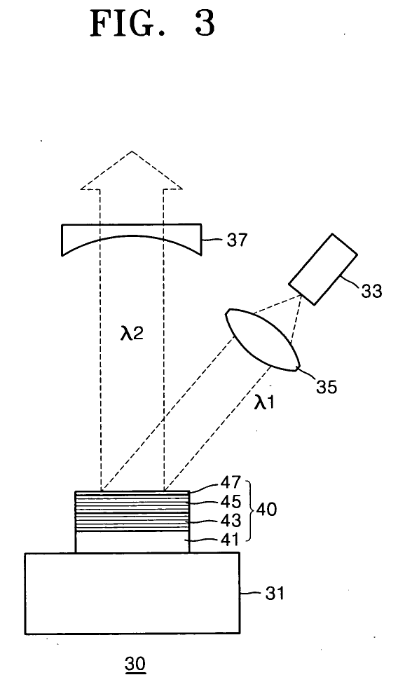

FIG. 3 schematically illustrates a vertical external cavity surface emitting laser (VECSEL) device 30 according to an embodiment of the present invention.

Referring to FIG. 3, the VECSEL device 30 includes a laser-pumping unit 40, a pump laser unit 33 and 35, and an external mirror 37. The laser-pumping unit 40 emits light having a predetermined wavelength. The pump laser unit 33 and 35 provides an optical pumping laser beam to the laser-pumping unit 40. The external mirror 37 transmits some of the light emitted from the laser-pumping unit 40 to output as a laser beam and reflects the another portion thereof to permit the laser-pumping unit 40 to reabsorb the reflected beam.

The pump laser unit 33 and 35 includes a light source, for example, a laser diode (LD) 33, which emits the optical pumping laser beam λ1, and a collimating lens 35, which collimates the laser beam λ1 to allow the laser beam λ1 to be incident on the laser-pumping unitlaser-pumping unit 40. In addition to the LD 33, any other appropriate light source can be used to emit the optical pumping laser beam λ1. Also, the optical pumping laser beam λ1 may not be coherent. However, the wavelength of the optical pumping laser beam λ1 should be shorter than that of the light λ2 emitted from the laser-pumping unit 40.

The laser-pumping unit 40 includes an active layer 45, a first reflector 43, and a second reflector 41. The active layer 45 absorbs the optical pumping laser beam λ1 and emits light having a predetermined wavelength. The first reflector 43 reflects the light emitted from the active layer 45 toward the external mirror 37. The second reflector 41 reflects the optical pumping laser beam λ1, which is not absorbed in the active layer 45 but transmits it back through the first reflector 43, toward the active layer 45.

The active layer 45 is a multiple layer structure in which quantum well (QW) layers (not shown) and barrier layers are alternately stacked. The QW layers are formed of a semiconductor material, such as InₓGa₁₋ₓAs_{y}P_{1-y}, InₓGa₁₋ₓAs, InₓGa₁₋ₓN_{y}As_{1-y}, InₓGa₁₋ₓAs_{y}Sb (here, 0.0<x<1.0, 0.0<y<1.0). The first reflector 43 may be, for example, a distributed Brag reflector (DBR), which is a multiple layer structure in which high refractive index layers (not shown) and low refractive index layers (not shown) are alternately stacked. Generally, a high refractive index layer is formed of, for example, AlₓGa₁₋ₓAs, and a low refractive index layer is formed of, for example, Al_{y}Ga_{1-y}As (here, x<y). In the first reflector 43, a thickness of each layer is ¼ the wavelength λ2 of the light emitted from the active layer 45, i.e., λ2/4. The first reflector 43, which is the compound semiconductor DBR as described above, forms a laser-resonator along with the external mirror 37.

In the meantime, the second reflector 41 has a high reflectance with respect to the optical pumping laser beam λ1. That is, the first reflector 43 reflects the light of wavelength λ2, while the second reflector 41 reflects light of wavelength λ1. The second reflector 41 may be a dielectric DBR (D-DBR) or a typical metal reflector made of Al or Ag, as examples. When the second reflector 41 is a D-DBR, it may include a multiple layer structure formed of dielectric materials, such as SiO₂, Al₂O₃, ZrO₂, TiO₂, and HfO₂. Similar to the first reflector 43, the second reflector 41 includes a multiple layer structure in which high refractive index dielectric layers and low refractive index dielectric layers are alternately stacked. In the second reflector 41, a thickness of each layer is ¼ the wavelength λ1 of the optical pumping laser beam. Dielectric materials constituting the second reflector 41 can be appropriately selected considering the wavelength of the optical pumping laser beam λ1.

The laser-pumping unit 40 may further include a heat sink 31, which radiates heat generated by the active layer 45 to cool the active layer 45. The heat sink 31 is located under the second reflector 41.

Selectively, an upper layer 47 may be further formed on the active layer 45. The upper layer 47 may be an anti-reflective layer or a reflective mirror. If the upper layer 47 is an anti-reflective layer, it prevents reflection of laser beam λ1 incident from the pump laser 33 on the laser-pumping unit 40 or prevents reflection of light λ2 which travel from the active layer 45 toward the external mirror 37, at an interface between the surface of the active layer 45 and air. In addition, the upper layer 47 prevents reflection of light reflected from the external mirror 37 toward the active layer 45, at the interface between the surface of the active layer 45 and air. If the upper layer 47 is a reflective mirror, the VECSEL device in this embodiment of the present invention is provided with two resonators. A first resonator is located between the first reflector 43 and the reflective mirror 47, i.e., located within the active layer 45, and a second reflector is located between the first reflector 43 and the external mirror 37. The two resonators included in the VECSEL device improve oscillation efficiency. Like the first reflector 43, the reflective mirror 37 may be a compound semiconductor DBR.

The operation of the above-described VECSEL device is as follows. At the outset, an optical pumping laser beam λ1 emitted from the pump laser 33 are collimated via the collimating lens 35 and incident on the laser-pumping unitlaser-pumping unit 40. Then, the active layer 45 of the laser-pumping unit 40 is excited by the laser beam λ1 and emits light λ2 having a predetermined wavelength. The wavelength of the light λ2 emitted from the active layer 45 depends on the structure and material of the active layer 45.

The light λ2 emitted from the active layer 45 reach the external mirror 37. The light λ2 are reflected by the external mirror 37 and then incident on the active layer 45 again. After that, the light λ2 are reflected by the first reflector 43, which is located under the active layer 45, toward the external mirror 37. Thus, the light λ2 emitted from the active layer 45 are repetitively reflected between the first reflector 43 and the external mirror 37 via the active layer 45. In this process, some of the light λ2 amplified in the active layer 45 are radiated as laser beam through the external mirror 37.

Meanwhile, some of the optical pumping laser beam λ1 are not absorbed in the active layer 45 but transmitted toward the first reflector 43. However, since the first reflector 43 is designed to have the highest reflectance with respect to the light λ2 emitted from the active layer 45, it cannot sufficiently reflect the optical pumping laser beam λ1. As a result, the optical pumping laser beam λ1 transmits the first reflector 43 and reach the second reflector 41. Then, the second reflector 41 reflects the optical pumping laser beam λ1 toward the active layer 45. Thus, the optical pumping laser beam λ1 is absorbed in the active layer 45, thereby contributing to optical pumping. Conventionally, since the optical pumping laser beam λ1 that transmits the first reflector 43 is directly absorbed in a substrate, optical pumping is not optimally efficient and heat generation is increased. However, in embodiments of the present invention, some of the optical pumping laser beam unabsorbed in the active layer 45 are reflected by the second reflector 41 and reused, thus greatly improving optical pumping efficiency.

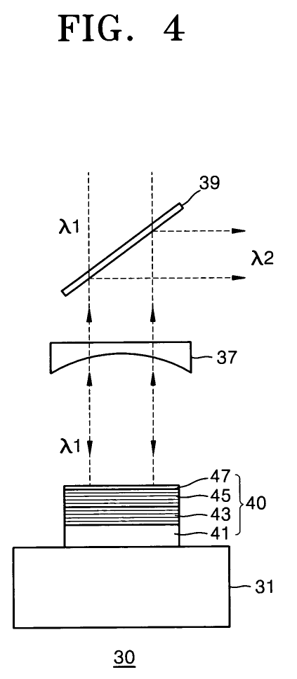

FIG. 4 schematically illustrates a VECESL device according to another embodiment of the present invention.

Referring to FIG. 4, the VECESL device is different from the VECSEL device shown in FIG. 3 in that optical laser beam λ1 radiated from a pump laser (not shown) transmit an external mirror 37 and are vertically incident on a laser-pumping unitlaser-pumping unit 40. Laser beam λ2, which is emitted from the laser-pumping unit 40 and radiated through the external mirror 37, is reflected by, for example, a beam splitter 39 and separated from the optical pumping laser beam λ1. The beam splitter 39 is an optical device that reflects or transmits light having a specific wavelength. As shown in FIG. 4, the beam splitter 39 of the present embodiment transmits the optical pumping laser beam λ1 but reflects the laser beam λ2 emitted from the laser-pumping unit 40.

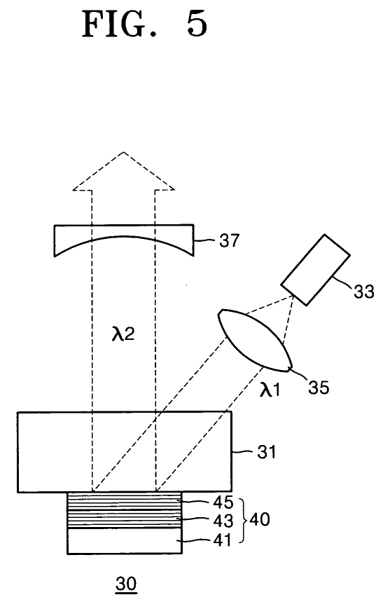

FIG. 5 schematically illustrates a VECSEL device according to yet another embodiment of the present invention. As shown in FIG. 5, the VECSEL device is different from the VECSEL device shown in FIG. 3 in that a heat sink 31 is formed not under a second reflector 41 but on an active layer 45. The heat sink 31 is made to contact the active layer 45, thus improving cooling efficiency. In this case, the heat sink 31 should be formed of a light transmitting material. For example, the heat sink 31 may be formed of transparent materials, such as diamond, silicon carbide, or sapphire.

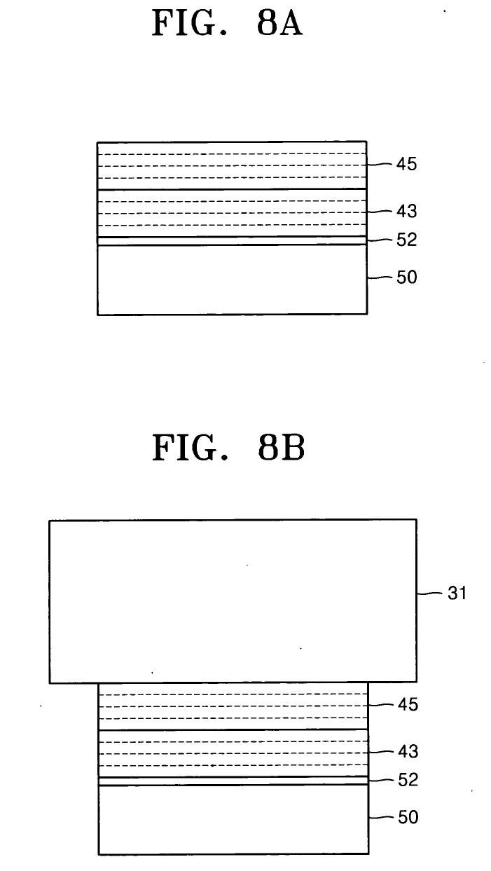

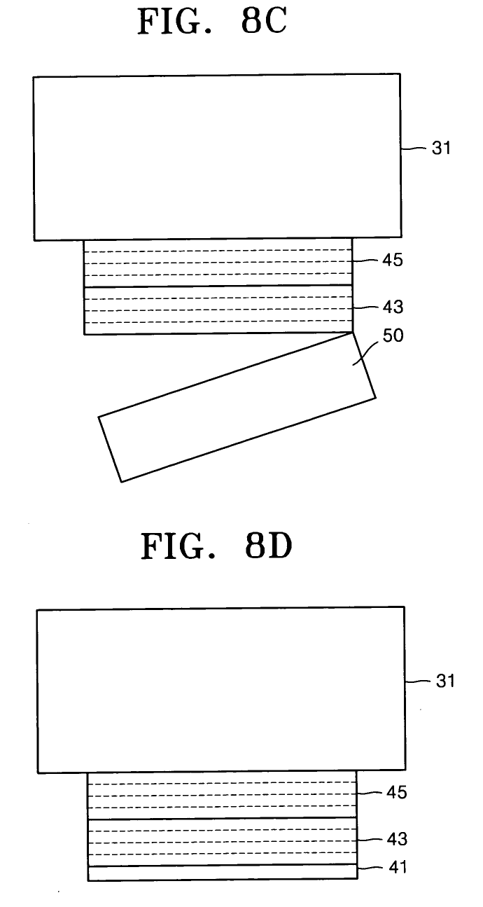

FIGS. 8A through 8D are cross-sectional views illustrating a method of manufacturing a laser-pumping unit 40 shown in FIG. 5.

Referring to FIG. 8A, a sacrificial layer 52 is formed on a substrate 50 formed of GaAs. The sacrificial layer 52 may be formed of, for example, AlAs or InGaP. A first reflector 43, such as a DBR, is formed on the sacrificial layer 52, and an active layer 45 is formed on the first reflector 43. Thereafter, as shown in FIG. 8B, a heat sink 31, which is formed of a transparent material, such as diamond, is stacked on the active layer 45.

Referring to FIG. 8C, the sacrificial layer 52 is removed using, for example, an etching process. Once the sacrificial layer 52 is removed, the first reflector 43 and the substrate 50, which were in contact with both surfaces of the sacrificial layer 52, respectively, are separated from each other. As shown in FIG. 8D, a second reflector 41 is deposited on the first reflector 43, thereby completing the laser-pumping unit 40 shown in FIG. 5.

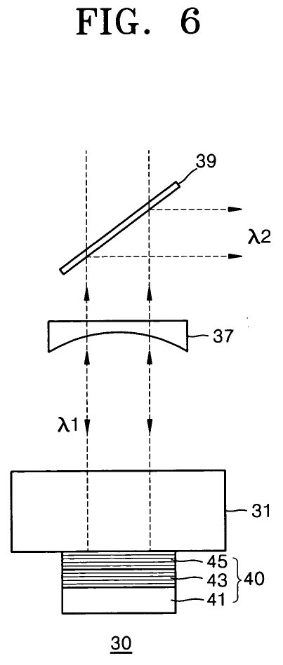

FIG. 6 schematically illustrates a VECSEL device according to further another embodiment of the present invention. The VECSEL device of the present embodiment is different from the VECSEL device shown in FIG. 5 in that optical pumping laser beam λ1 emitted from a pump laser (not shown) transmits an external mirror 37 and is vertically incident on a laser-pumping unit 40. Like in the embodiment as described with reference to FIG. 4, laser beam λ2, which is emitted from the laser-pumping unit 40 and radiated through the external mirror 37, is reflected through a beam splitter 39 and separated from the optical pumping laser beam λ1.

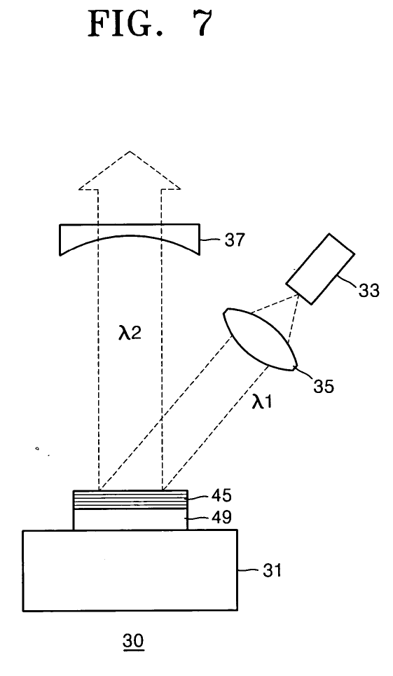

In the above-described embodiments, the laser-pumping unit 40 includes the first reflector 43 for reflecting the light λ2 emitted from the active layer 45 and the second reflector 41 for reflecting the optical pumping laser beam λ1 separately. However, it is possible to use only one reflector to reflect the two kinds of beam λ1 and λ2 as shown in FIG. 7.

FIG. 7 is a schematic cross-sectional view of a surface emitting laser device according to a further another embodiment of the present invention.

Referring to FIG. 7, a single reflector 49 is disposed instead of the first and second reflectors 43 and 41 under an active layer 45. This integral reflector 49 is typically a dielectric DBR that can reflect light having a broad wavelength band. However, a semiconductor DBR that has a sufficiently high reflectance (e.g., 99% or higher) with respect to both the beam λ1 and λ2 can be used instead.

As explained thus far, a laser-pumping unit of embodiments of the present invention further includes a second reflector or a reflector capability at at least the two relevant wavelengths, which reflects an optical pumping laser beam unabsorbed in an active layer, toward the active layer. Thus, a greater amount of the optical laser beam can be absorbed in the active layer, thus enhancing the optical pumping efficiency of a laser device.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A semiconductor laser device comprising:
a laser-pumping unit emitting light having a predetermined wavelength; and
a pump laser providing an optical pumping laser beam to the laser-pumping unit,
wherein the lase-pumping unit comprises:
an active layer absorbing the optical pumping laser beam to emit light having a predetermined wavelength;
a first reflector reflecting the light emitted from the active layer; and
a second reflector reflecting the optical pumping laser beam, which are not absorbed in the active layer but transmit through the first reflector, toward the active layer.

2. The device of claim 1, wherein the first reflector is a compound semiconductor distributed Brag reflector, in which a plurality of high refractive index layers and a plurality of low refractive index layers are alternately stacked.

3. The device of claim 1, wherein the second reflector is any one of a dielectric distributed Brag reflector and a metal reflector.

4. The device of claim 3, wherein the dielectric distributed Brag reflector is formed of at least one selected from the group consisting of SiO₂, Al₂O₃, ZrO₃, TiO₃, and HfO₂.

5. The device of claim 1, wherein the first reflector and the second reflector constitute a single integral distributed Brag reflector having a predetermined reflectance or higher with respect to both wavelengths of light emitted from both the active layer and the optical pumping laser beam.

6. The device of claim 1, wherein the laser-pumping unit further comprises a heat sink radiating heat generated by the active layer to cool the active layer.

7. The device of claim 6, wherein the heat sink is attached to the second reflector.

8. The device of claim 6, wherein the heat sink is attached to a surface of the active layer on which laser beam are incident and is formed of a transparent material.

9. The device of claim 1, further comprising an external mirror located outside the laser-pumping unit, transmitting some of the light emitted from the laser pumping-unit to output the transmitted beam as laser beam, and reflecting the other light thereof to permit the reflected beam to be reabsorbed in the laser-pumping unit.

10. The device of claim 9, wherein the external mirror is located between the laser-pumping unit and the pump laser, and a beam splitter is located between the external mirror and the pump laser in order to separate the optical pumping laser beam and the laser beam emitted from the active layer.

11. The device of claim 1, wherein the laser-pumping unit includes a third reflector located on the active layer to reflect the light reflected from the first reflector toward the active layer.

12. The device of claim 11, wherein the third reflector is a compound semiconductor distributed Brag reflector.

13. The device of claim 1, wherein the laser-pumping unit includes an anti-reflective layer located on the active layer to prevent reflection of the light incident on the active layer.

14. A laser-pumping unit for a surface emitting laser device, which absorbs an optical pumping laser beam emitted from a pump laser and emits light having a predetermined wavelength, the laser-pumping unit comprising:
an active layer absorbing the optical pumping laser beam to emit the light having the predetermined wavelength;
a first reflector reflecting the light emitted from the active layer; and
a second reflector reflecting the optical pumping laser beam, which is not absorbed in the active layer but transmit through the first reflector, toward the active layer.

15. The unit of claim 14, wherein the first reflector is a compound semiconductor distributed Brag reflector in which a plurality of high refractive index layers and a plurality of low refractive index layers are alternately stacked.

16. The unit of claim 14, wherein the second reflector is any one of a dielectric distributed Brag reflector and a metal reflector.

17. The unit of claim 15, wherein the dielectric distributed Brag reflector is formed of at least one selected from the group consisting of SiO₂, Al₂O₃, ZrO₃, TiO₃, and HfO₂.

18. The unit of claim 14, wherein the first reflector and the second reflector constitute a single integral distributed Brag reflector having a predetermined reflectance or higher with respect to both the light emitted from the active layer and the optical pumping laser beam.

19. The unit of claim 14, wherein the laser-pumping unit further comprises a heat sink radiating heat generated by the active layer to cool the active layer.

20. The unit of claim 19, wherein the heat sink is attached to the second reflector.

21. The unit of claim 19, wherein the heat sink is attached to a surface of the active layer on which laser beam are incident and formed of a transparent material.

22. The unit of claim 14, further comprising a third reflector located on the active layer to reflect the light reflected from the first reflector toward the active layer.

23. The unit of claim 22, wherein the third reflector is a compound semiconductor distributed Brag reflector.

24. The unit of claim 14, wherein the laser-pumping unit includes an anti-reflective layer located on the active layer to prevent reflection of the light incident on the active layer.

25. A method of manufacturing a laser-pumping unit for a surface emitting laser device, which absorbs an optical pumping laser beam emitted from a pump laser and emits light having a predetermined wavelength, the method comprising:
forming a sacrificial layer on a substrate;
stacking a first reflector, which is a distributed Brag reflector, on the sacrificial layer;
stacking an active layer on the first reflector, the active layer absorbing the optical pumping laser beam to emit light having a predetermined wavelength;
stacking a light transmissive heat sink on the active layer;
separating the substrate from the first reflector by etching the sacrificial layer; and
depositing a second reflector under the first reflector, the second reflector reflecting the optical pumping laser beam, which are not absorbed in the active layer but transmit the first reflector, toward the active layer.

26. The method of claim 25, wherein the sacrificial layer is formed of at least one of AlAs and InGaP.

27. The method of claim 25, wherein the second reflector is any one of a dielectric distributed Brag reflector and a metal reflector.

28. The method of claim 27, wherein the second reflector is formed of at least one selected from the group consisting of SiO₂, Al₂O₃, ZrO₃, TiO₃, and HfO₂.

29. The method of claim 25, further comprising forming the first reflector by alternatively stacking a plurality of high refractive index layers and a plurality of low refractive index layers.

30. The method of claim 29, wherein the high refractive index layer is formed of AlₓGa₁₋ₓAs, the low refractive index layer is formed of Al_{y}Ga_{1-y}As, and x<y.
